(19) United States
(12) Patent Application Publication
(10) Pub. No.: US 2005/0071158 A1
(43) Pub. Date: Mar. 31, 2005

(54) Apparatus and method for detecting user speech

(75) Inventor: Roger Graham Byford, Apollo, PA (US)

Correspondence Address: WOOD, HERRON & EVANS, LLP, 2700 CAREW TOWER, 441 VINE STREET, CINCINNATI, OH, 45202, US

(73) Assignee: Vocollect, Inc., Pittsburgh, PA (US)

(21) Appl. No.: 10/671,142

(22) Filed: Sep. 25, 2003

(51) Int. Cl. G10L 15/00

(52) U.S. Cl. 704/233

(57) ABSTRACT

An apparatus for detecting user speech comprises a first microphone and at least a second microphone, each operable to generate sound signals with respective signal characteristics. The first microphone is operable to capture a greater proportion of speech sounds of a user than the second microphone. Processing circuitry processes the signal characteristics of the sound signals generated by the first microphone and the second microphone to determine variations in those signal characteristics for determining if the user is speaking.

### RELATED APPLICATIONS

This application is related to the application entitled “Wireless Headset for Use in Speech Recognition Environment by Byford et al. and filed on Ser. No. ______, which application is incorporated herein by reference in its entirety.

### FIELD OF THE INVENTION

This invention relates generally to computer terminals and peripherals and more specifically to portable computer terminals and headsets used in voice-driven systems.

### BACKGROUND OF THE INVENTION

Wearable, mobile and/or portable computer terminals are used for a wide variety of tasks. Such terminals allow workers using them to maintain mobility, while providing the worker with desirable computing and data-processing functions. Furthermore, such terminals often provide a communication link to a larger, more centralized computer system. One example of a specific use for a wearable/mobile/portable terminal is inventory management. An overall integrated management system may involve a combination of a central computer system for tracking and management, a plurality of mobile terminals and the people (“users”) who use the terminals and interface with the computer system.

To provide an interface between the central computer system and the workers, such wearable terminals and the systems to which they are connected are oftentimes voice-driven; i.e., are operated using human speech. To communicate in a voice-driven system, for example, the worker wears a headset, which is coupled to his wearable terminal. Through the headset, the workers are able to receive voice instructions, ask questions, report the progress of their tasks, and report working conditions, such as inventory shortages, for example. Using such terminals, the work is done virtually hands-free without equipment to juggle or paperwork to carry around.

As may be appreciated, such systems are often utilized in noisy environments where the workers are exposed to various often-extraneous sounds that might affect their voice communication with their terminal and the central computer system. For example, in a warehouse environment, extraneous sounds such as box drops, noise from the operation of lift trucks, and public address (P.A.) system noise, may all be present. Such extraneous sounds create undesirable noises that a speech recognizer function in a voice-activated terminal may interpret as actual speech from a headset-wearing user. P.A. system noises are particularly difficult to address for various reasons. First, P.A. systems are typically very loud, to be heard above other extraneous sounds in the work environment. Therefore, it is very likely that a headset microphone will pick up such sounds. Secondly, the noises themselves are not unintelligible noises, but rather are human speech, which a terminal and its speech-recognition hardware are equipped to handle and process. Therefore, such extraneous sounds present problems in the smooth operation of a voice-driven system using portable terminals.

There have been some approaches to address such extraneous noises. However, such traditional approaches and noise cancellation programs have various drawbacks. For example, noise-canceling microphones have been utilized to cancel the effects of extraneous sounds. However, in various environments, such noise-canceling microphones do and programs not provide sufficient signal-to-noise ratios to be particularly effective.

Another solution that has been proposed and utilized is to have “garbage” models, which are utilized by the terminal hardware and its speech recognition features to eliminate certain noises. However, such “garbage” models are difficult to collect and are also difficult to implement and use. Furthermore, “garbage” models are typically useful only for a small set of well-defined noises. Obviously, such “garbage” noises cannot include human speech as the system is driven by speech commands and responses. Therefore, “garbage” models are generally worthless for external speech noises, such as those generated by a P.A. system.

Therefore, there is a particular need for addressing extraneous sounds in an environment using voice-driven systems to ensure smooth operation of such systems. There is a further need for addressing extraneous noises in a simple and cost-effective manner that ensures proper operation of the terminal and headset. Particularly, there is a need for a system that will address extraneous human voice noise, such as that generated by a P.A. system. The present invention provides solutions to such needs in the art and also addresses the drawbacks of prior art solutions.

### BRIEF DESCRIPTION OF THE DRAWINGS

The accompanying drawings, which are incorporated in and constitute a part of this specification, illustrate embodiments of the invention and, together with a general description of the invention given above and the detailed description given below, serve to explain the invention.

FIG. 1 is a perspective view of a worker using a terminal and headset in accordance with the present invention.

FIG. 2 is a schematic block diagram of a system incorporating the present invention.

FIG. 3 is a schematic block diagram of an exemplary embodiment of the present invention.

FIG. 4 is a schematic block diagram of an exemplary embodiment of the present invention.

### DETAILED DESCRIPTION OF EMBODIMENTS OF THE INVENTION

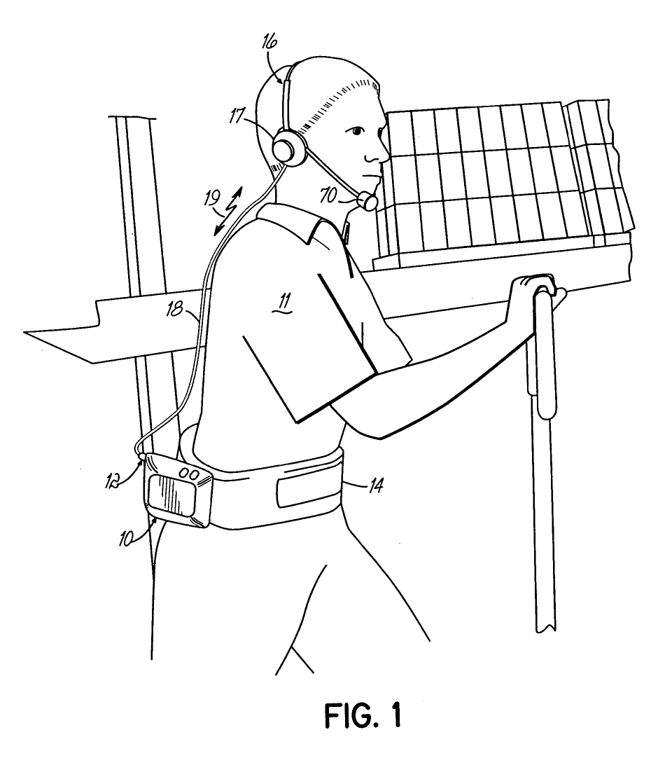

Referring to FIG. 1, there is shown, in use, an apparatus including a portable and/or wearable terminal or computer 10 and headset 16, which apparatus incorporates an embodiment of the present invention. The portable terminal may be a wearable device, which may be worn by a worker 11 or other user, such as on a belt 14 as shown. This allows hands-free use of the terminal. Of course, the terminal might also be manually carried or otherwise transported, such as on a lift truck. The use of the term “terminal” herein is not limited and may include any computer, device, machine, or system which is used to perform a specific task, and which is used in conjunction with one or more peripheral devices such as the headset 16.

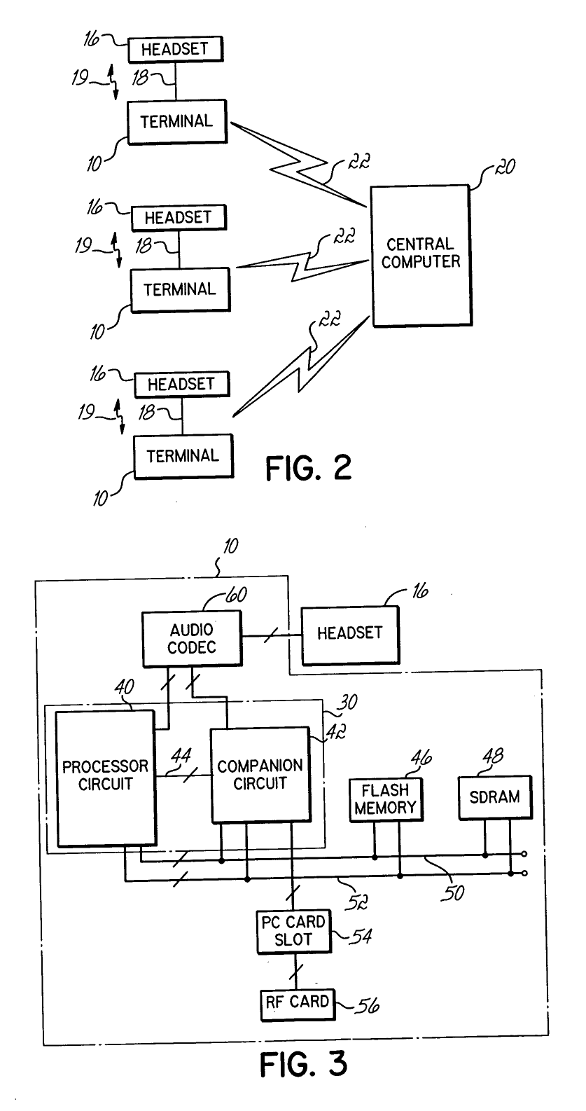

The portable terminals 10 operate in a voice-driven system and permit a variety of workers 11 to communicate with one or more central computers (see FIG. 2), which are part of a larger system for sending and receiving information regarding the activities and tasks to be performed by the worker. The central computer 20 or computers may run one or more system software packages for handling a particular task, such as inventory and warehouse management.

Terminal 10 communicates with central computer 20 or a plurality of computers, such as with a wireless link 22. To communicate with the system, one or more peripheral devices or peripherals, such as headsets 16, are coupled to the terminals 10. Headsets 16 may be coupled to the terminal by respective cords 18 or by a wireless link 19. The headset 16 is worn on the head of the user/worker 11 with the cord out of the way and allows hands-free operation and movement throughout a warehouse or other facility.

FIG. 3 is a block diagram of one exemplary embodiment of a terminal and headset for utilizing the invention. A brief explanation of the interaction of the headset and terminal is helpful in understanding the voice-driven environment of the invention. Specifically, the terminal 10 for communicating with a central computer may comprise processing circuitry 30, which may include a processor 40 for controlling the operation of the terminal and other associate processing circuitry. As may be appreciated by a person of ordinary skill in the art, such processors generally operate according to an operating system, which is a software-implemented series of instructions. The processing circuitry 30 may also implement one or more application programs in accordance with the invention. In one embodiment of the invention, a processor, such as an Intel SA-1110, might be utilized as the main processor and coupled to a suitable companion circuit or companion chip 42 by appropriate lines 44. One suitable companion circuit might be an SA-1111, also available from Intel. The processing circuitry 30 is coupled to appropriate memory, such as flash memory 46 and random access memory (SDRAM) 48. The processor and companion chip 40, 42, may be coupled to the memory 46, 48 through appropriate busses, such as 32 bit parallel address bus 50 and data bus 52.

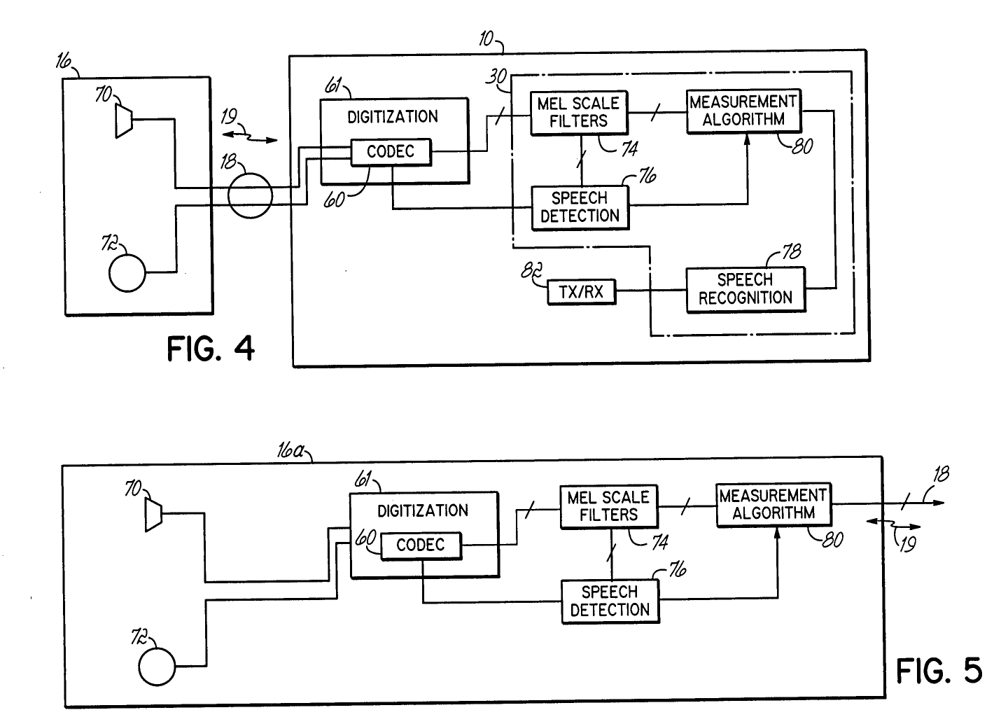

As noted further below, the processing circuitry 30 may also incorporate audio processing circuits such as audio filters and correlation circuitry associated with speech recognition (See FIG. 4). One suitable terminal for implementing the present invention is the Talkman® product available from Vocollect of Pittsburgh, Pa.

To provide wireless communications between the portable terminal 10 and central computer 20, the terminal 10 may also utilize a PC card slot 54, so as to provide a wireless ethernet connection, such as an IEEE 802.11 wireless standard. RF communication cards 56 from various vendors might be coupled with the PCMCIA slot 54 to provide communication between terminal 10 and the central computer 20, depending on the hardware required for the wireless RF connection. The RF card allows the terminal to transmit (TX) and receive (RX) communications with computer 20.

In accordance with one aspect of the present invention, the terminal is used in a voice-driven system, which uses speech recognition technology for communication. The headset 16 provides hands-free voice communication between the worker 11 and the central computer, such as in a warehouse management system. To that end, digital information is converted to an audio format, and vice versa, to provide the speech communication between the system and a worker. For example, in a typical system, the terminal 10 receives digital instructions from the central computer 90 and converts those instructions to audio to be heard by a worker 11. The worker 11 then replies, in a spoken language, and the audio reply is converted to a useable digital format to be transferred back to the central computer of the system.

For conversion between digital and analog audio, an audio coder/decoder chip or CODEC 60 is utilized, and is coupled through an appropriate serial interface to the processing circuitry components, such a one or both of the processors 40, 42. One suitable audio circuit, for example, might be a UDA 1341 audio CODEC available from Philips.

In accordance with the principles of the present invention, FIG. 4 illustrates, in block diagram form, one possible embodiment of a terminal implementing the present invention. As may be appreciated, the block diagrams show various lines indicating operable interconnections between different functional blocks or components. However, various of the components and functional blocks illustrated might be implemented in the processing circuitry 30, such as in the actual processor circuit 40 or the companion circuit 42. Accordingly, the drawings illustrate exemplary functional circuit blocks and do not necessarily illustrate individual chip components. As noted above, the available Talkman® product might be modified for incorporating the present invention, as discussed herein.

Referring to FIG. 4, a headset 16 is illustrated for use in the present invention. The headset 16 incorporates a first microphone 70 and a second microphone 72. Alternative embodiments might use additional microphones along with microphone 72. For example extra microphones might be located in each earcup of a headset. For the purposes of explaining one embodiment of the invention, a single additional microphone is discussed. Each of the microphones is operable to detect sounds, such as voice or other sounds, and to generate sound signals that have respective signal levels. In one embodiment of the invention, both of the microphones may have generally equal operational characteristics. Alternatively, the microphones might be operatively different. For example, the first microphone 70 is generally directed to be used to detect the voice of the headset user for processing voice instructions and responses. Therefore, it is desirable that microphone 70 be somewhat sophisticated for addressing voice implementations. The second microphone 72 is utilized herein to implement reduction of the effects of extraneous sounds in the voice-driven system. Microphone 72 functions simply to hear the extraneous sounds and not exactly to process those sounds into meaningful commands or responses. As such, microphone 72 might also be a similar sophisticated voice microphone, or alternatively, might be an omni directional microphone for processing extraneous sounds from the work environment.

In accordance with one aspect of the present invention, microphone 70 is positioned such that when the headset 16 is worn by a user, the first microphone 70 is positioned closer to the mouth of the user than is the second microphone 72. In that way, the first microphone captures a greater proportion of speech sounds of a user. In other words, speech from a user will be captured predominantly by the microphone 70. Referring to FIG. 1, microphone 70 is shown hung from a boom in front of the user's mouth. As such, the first microphone 70 is more susceptible to detecting the speech and voice sound signals of the user. Generally, in a voice-driven system, the headset is set up to have at least the first microphone 70. In retrofitting an existing product to incorporate the present invention, the headset might be modified to include one or more additional microphones 72 with the extra signal being carried to the terminal 10 on other channels of the CODEC 60. The second microphone 72, as used in the invention is for detecting the extraneous sounds and not so much the speech of the user although it may detect some user speech. Therefore, it is desirable that microphone 72 be placed away from the user's mouth, such as in the earpiece 17 of the headset. In one embodiment, the first microphone 70 will be coupled to one half of the stereo channels and addressed by the other CODEC and microphone 72 could be handled by the other stereo channel. As such, the present invention might be implemented in existing systems without a significant increase in hardware or processing burden on the system. The cost of such a modification would be relatively small, and the reliability of the system utilizing the invention is similar to one that is not modified to incorporate the present invention.

Outputs from first and second microphones 70, 72 are coupled to terminal 10 via a wired link or cord 18 or a wireless link 19, as illustrated in FIG. 4. Audio signals from the microphones 70, 72 are directed to suitable digitization circuitry 61, such as the CODEC 60. The CODEC digitizes the analog audio signals into digital audio signals that are then processed according to aspects of the present invention. Generally, such digitization will be done in voice-driven systems for the purpose of speech recognition. The digitized audio sound signals are then directed to the processing circuitry 30 for further processing in accordance with the principles of the present invention.

Generally, such processing circuitry 30 will incorporate audio filtering circuitry, such as mel scale filtering circuitry 74 or other filtering circuitry. Mel scale filtering circuitry is known in the art of speech recognition and provides an indication of the energy, such as the power spectral density, of the signals. Utilizing the measured difference and/or variation between the two sound signal levels generated by the first and second microphones 70, 72, the present invention determines when the user is speaking and, generally, will pass the sound signal for the first microphone, or headset microphone 70 to the speech recognition circuitry only when the variation in the measurement indicates that the first microphone 70 is detecting user speech and not just extraneous background noise. As used herein, the term “sound signal” is not limited only to an analog audio signal, but rather is used to refer to signals generated by the microphones throughout their processing. Therefore, “sound signal” is used to refer broadly to any signal, analog or digital, associated with the outputs of the microphones and anywhere along the processing continuum. The processing circuitry 30 may also include speech detection circuitry 76 operatively coupled to the CODEC 60 and the mel scale filters 74. The speech detection circuitry 76 utilizes an algorithm that detects whether the sound that is picked up by the speech microphone 70 is actually speech and not just some unintelligible sound from the user. Speech detection circuitry may provide an output to the measurement algorithm 80 for further implementing the invention.

Referring again to FIG. 4, the processing circuitry 30 of the invention implements a measurement algorithm and has appropriate circuitry 80 and software for implementing such an algorithm to measure and process one or more common characteristics of the microphone signals, such as the two signal levels from the mel scale filters 74 associated with each of the sound signals of microphones 70, 72. Primarily, the variation between the two sound signal levels is measured and processed. For example, the variation might be measured as the sum of the mel channel difference values, or the sum of some subset of those values, or by some other algorithm. Generally, on embodiment of the invention determines the difference between the sound signal levels produced by the microphones 70, 72 and uses that difference for reducing the effects of extraneous sounds in a voice-driven system.

Although in the embodiment discussed herein, signal energy or power levels from mel scale filters are used for being processed to determine when a user is speaking, other signal characteristics might be processed. For example, frequency characteristics, or signal amplitude and or phase characteristics might also be analyzed. Therefore, the invention also covers analysis of other signal characteristics that are common between the two or more signals be analyzed or processed.

One embodiment of the present invention operates on the relative change in the variation between the sound signal levels generated by microphones 70, 72 when the user is speaking and when the user is not speaking. For the purposes of providing a baseline, the processing circuitry monitors those periods when it appears the user is not speaking. For example, speech detection circuitry 76 might be utilized in that regard to measure the energy levels from the output signals of the microphones to determine when user speech is not being detected by the microphone 70.

When the user is not speaking, generally any sounds picked up by the microphones 70, 72 are extraneous sounds or extraneous noise from the environment. For such extraneous noises, generally both microphones will “hear” the noise similarly. Of course, there may be some variances in the signal levels based upon the type of microphones utilized and their positioning with respect to the headset and the user. For example, one microphone might be oriented in a direction closer to the source of the extraneous noise.

Therefore, the invention does not require that the microphones “hear” the extraneous sounds identically, only that there is not a significant change in the relative variation or difference in the sound signal levels as various extraneous noises are detected or picked up.

The example invention embodiment works on a relative measurement of the sound levels and the variation or difference in each sound level. The measurements are made over a predetermined time base with respect to the external noise levels when the user is speaking and when the user is not speaking. The non-speaking condition is used as a baseline measurement. This baseline difference or variation may be filtered to avoid rapid fluctuation, and the difference measured between the two microphones 70, 72 will be calibrated. The baseline may then be stored in memory and retrieved as necessary. The calibrated variation will operate as the baseline, and subsequent measurements of sound signal level differences will be utilized to determine whether the change in that measured difference with respect to the baseline variation indicates that a user is speaking. In accordance with one aspect of the present invention, the headset microphone signal (which detects user speech) will be passed to speech recognition circuitry 78 only when user speech is detected, with or without the extraneous background noise.

For example, when the user speaks, the difference or variation between the sound signal levels from the first and second microphones will change. Preferably that change is significant with respect to the baseline variation. That is, the change in the difference may exceed the baseline difference by a threshold or predetermined amount. As noted above, that difference may be measured in several different ways, such as the sum of the mel channel difference values generated by the mel scale filters 74. Of course, other algorithms may also be utilized. Based upon the speech of the user, the signal level from the headset microphone or first microphone 70 will increase significantly relative to that from the additional microphone or second microphone 72 because the microphone 70 captures a greater proportion of speech sounds of a user. For example, when both microphones are utilized in a headset worn by a user, the first microphone to detect the user's speech is positioned in the headset closer to the mouth of the user than the second microphone (see FIG. 1). As such, the sound signal level generated by the first microphone will increase significantly when the user speaks. Furthermore, in accordance with one aspect of the present invention, the second microphone might be omnidirectional, while the first microphone is more directional for capturing the user's speech. The increase in the signal level from the first microphone 70 and/or the relative difference in the signal levels of the microphones 70, 72 is detected by the circuitry 80 utilized to implement the measurement algorithm. With respect to the baseline variation, which was earlier determined by the measurement algorithm circuitry 80, a determination is made with respect to whether the user is speaking, based on the change in the signal levels of the microphone 70 with respect to the baseline measured when the user is not speaking. For example, the variation between the signal characteristics of the respective microphone signals will exceed the baseline variation a certain amount as to indicate speech at microphone 70.

Alternatively, the signal measurement from the first microphone might be summed or otherwise processed with the baseline for determining when a user is speaking.

Generally, for operation of the voice-driven system, the signals from the headset microphone 70 must be further processed with speech recognition processing circuitry 78 for communicating with the central computer or central system 20. In accordance with one aspect of the present invention, when the measurement algorithm 80 determines that the user is speaking, signals from the headset microphone are passed to the speech recognition circuitry 78 for further processing, and are then passed on through appropriate RX/TX circuitry 82, such as to a central computer. If the user is not speaking, such signals, which would be indicative of primarily extraneous sounds or noise, are not passed for speech recognition processing or further processing. In that way, various of the problems and drawbacks in voice recognition systems are addressed. For example, various extraneous noises, including P.A. system voice noises, are not interpreted as useful speech by the terminal and are not passed on as such. Such a solution, in accordance with the present invention, is straightforward and, therefore, is relatively inexpensive to implement. Current systems, such as the Talkman® system, may be readily retrofitted to incorporate the invention. Furthermore, expensive noise-canceling techniques and difficult “garbage” models do not have to be implemented. In accordance with the voice-driven system, any recognized speech from circuitry 78 may be passed for transmission to the central computer through appropriate transmission circuitry 82, such as the RF card 56, illustrated in FIG. 3.

While FIG. 4 illustrates the speech processing circuitry in the terminal, it might alternatively be located in the central computer and therefore the signal may be transmitted to the central computer for further speech processing.

While the measurement algorithm processing circuitry for processing the signal characteristics and determining if the user is speaking is shown as a single block, it will be readily understandable that the processing circuitry may be implemented in various different scenarios.

In accordance with one implementation of the invention, as discussed above, mel channel signal values are utilized. In another embodiments of the invention, a simple energy level measurement might be utilized instead of the mel scale filter bank values. As such, appropriate energy measurement circuitry will be incorporated with the output of the CODEC in the processing circuitry. Such an energy level measurement would require the use of matched microphones. That is, both microphones 70 and 72 would have to be sophisticated voice microphones so that they would respond somewhat similarly to the frequency of the signals that are detected. A second microphone 72, which is a sophisticated and expensive voice microphone, increases the cost of the overall system. Therefore, the previously disclosed embodiment utilizing the mel scale filter bank, along with the measurement of the change in the difference between the sound signal levels, will eliminate the requirement of having matched microphones.

Turning again to FIG. 4, various of the component blocks illustrated as part of the processing circuitry 30 may be implemented in processors, such as in the processor circuit 40 and companion circuit 42, as illustrated in FIG. 3. Alternatively, those components might be stand-alone components, which ultimately couple with each other to operate in accordance with the principles of the present invention.

FIG. 5 illustrates an alternative embodiment of the invention in which a headset 16a for use with a portable terminal is modified for implementing the invention. Specifically, the headset incorporates the CODEC 60 and some of the processing circuitry, such as the audio filters 74, speech detection circuitry 76, and measurement algorithm circuitry 80. With such circuitry incorporated in the headset, in accordance with one aspect of the present invention, sound signals from the speech microphone 70 will only be passed to the terminal, such as through a cord 18 or a wireless link 19, when the headset has determined that the user is speaking. That is, similar to the way in which the processing circuitry will pass the appropriate signals to the speech recognition circuitry 78 when the user is speaking, in the embodiment of FIG. 5 the headset will primarily only pass the appropriate signals to the terminal when the invention determines that the user is speaking, even if the extraneous sound includes speech signals, such as from a P.A. system. Alternatively, other circuitry such as speech recognition circuitry may be incorporated in the headset, such as with the speech detection circuitry, so that processed speech is sent to a central computer or elsewhere when speech is detected.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

1. An apparatus for detecting user speech comprising:
a first microphone and at least a second microphone each operable to generate sound signals with respective signal characteristics;
the first microphone operable to capture a greater proportion of speech sounds of a user than the second microphone;
processing circuitry operable to process the signal characteristics of the sound signals generated by the first microphone and the second microphone to determine variations in those signal characteristics for determining if the user is speaking.

2. The apparatus of claim 1 further comprising processing circuitry operable to process the first microphone sound signals.

3. The apparatus of claim 1 further comprising speech recognition circuitry operably coupled with the first microphone for selectively recognizing speech sounds detected by the first microphone.

4. The apparatus of claim 1 wherein the first microphone is located relative to the second microphone to capture a greater proportion of speech sounds of a user.

5. The apparatus of claim 1 further comprising a headset to be worn by a user and housing the first and second microphones.

6. The apparatus of claim 5 wherein the first microphone is positioned in the headset to be closer to a mouth of the user than the second microphone when the headset is worn.

7. The apparatus of claim 1 wherein the signal characteristics processed are sound signal levels.

8. The apparatus of claim 1 wherein the signal characteristics include at least one of energy level characteristics, frequency characteristics, amplitude characteristics and phase characteristics.

9. The apparatus of claim 1 further comprising processing circuitry operable for initially determining a variation between signal characteristics of the first and second sound signals when the user is not speaking and then using that variation as a baseline.

10. The apparatus of claim 9 wherein the processing circuitry is operable for determining if the signal characteristics variation exceeds the baseline variation by a predetermined amount to determine if the user is speaking.

11. The apparatus of claim 1 wherein the second microphone is an omnidirectional microphone.

12. The apparatus of claim 1 further comprising mel scale filters, the processing circuitry operable to use outputs of the mel scale filters for determining variations in the signal characteristics.

13. The apparatus of claim 1 further comprising circuitry for measuring energy levels of sound signals from the first and second microphones, the processing circuitry operable to use the measured energy levels for determining variations in the sound signal levels.

14. A terminal system for detecting user speech comprising:
a headset including first and second microphones operable to generate sound signals with respective signal characteristics, the first microphone operable to capture a greater proportion of speech sounds of a user wearing the headset than the second microphone;
a terminal including processing circuitry operable to process the signal characteristics of the first microphone signals and the signal characteristics of the second microphone to determine variations in those signal characteristics for determining if the user is speaking.

15. The terminal system of claim 14 further comprising processing circuitry operable to process the first microphone sound signals.

16. The terminal system of claim 14 the terminal further comprising speech recognition circuitry operably coupled with the first microphone for selectively recognizing speech sounds detected by the first microphone.

17. The terminal system of claim 14 wherein the first microphone is positioned in the headset to be closer to a mouth of the user than the second microphone when the headset is worn.

18. The terminal system of claim 14 wherein the signal characteristics processed are sound signal levels.

19. The terminal system of claim 14 wherein the signal characteristics include at least one of energy level characteristics, frequency characteristics, amplitude characteristics and phase characteristics.

20. The terminal system of claim 14 further comprising processing circuitry operable for initially determining a variation between signal characteristics of the first and second sound signals when the user is not speaking and then using that variation as a baseline for subsequent processing of other variations in the signal characteristics for both the first and second microphones.

21. The terminal system of claim 14 wherein the processing circuitry is operable for determining if the signal characteristics variation exceeds the baseline variation by a predetermined amount to determine if the user is speaking.

22. A headset for use with a terminal having speech recognition capabilities, the headset comprising:
a first microphone and a second microphone each operable to generate sound signals with respective signal characteristics, the first microphone operable to capture a greater proportion of speech sounds of a user than the second microphone; and
processing circuitry operable to process the signal characteristics of the sound signals generated by the first microphone and the second microphone to determine variations in those sound signal characteristics for determining if the user is speaking.

23. The headset of claim 22 further comprising processing circuitry operable to pass the first microphone sound signals to the terminal when it has been determined that the user is speaking.

24. The headset of claim 22 wherein the first microphone is located relative to the second microphone to capture a greater proportion of speech sounds of a user.

25. The headset of claim 22 wherein the signal characteristics processed are sound signal levels.

26. The headset of claim 22 wherein the signal characteristics include at least one of energy level characteristics, frequency characteristics, amplitude characteristics and phase characteristics.

27. The headset of claim 22 further comprising processing circuitry is operable for initially determining a variation between signal characteristics of the first and second sound signals when the user is not speaking and then using that variation as a baseline for subsequent comparison of other variations in the signal characteristics for both the first and second microphones.

28. The headset of claim 27 wherein the processing circuitry is operable for determining if the signal characteristics variation exceeds the baseline variation by a predetermined amount to determine if the user is speaking.

29. The headset of claim 22 further comprising mel scale filters, the processing circuitry operable to use outputs of the mel scale filters for determining variations in the signal characteristics.

30. The headset of claim 22 further comprising circuitry for measuring energy levels of the sound signals from the first and second microphones, the processing circuitry operable to use the measured energy levels for determining variations in the sound signal levels.

31. An apparatus in a voice-driven system for detecting user speech, comprising:
a plurality of microphones separated on the body of a user and developing a plurality of signals with signal characteristics, at least a first signal of said plurality of signals including a greater proportion of user speech than a second signal of said plurality of signals which is characterized predominantly by ambient sounds; and
processing circuitry configured to process said plurality of signals for determining variations in their signal characteristics to develop an output signal that reveals the presence or absence of user speech.

32. The apparatus of claim 31 wherein said processing circuitry generates a signal characteristic baseline from which said output signal is developed.

33. The apparatus of claim 32 wherein said baseline is stored in a memory.

34. The apparatus of claim 32 wherein said baseline represents a difference in signal level over a predetermined time base between said first and second signals.

35. The apparatus of claim 32 wherein said output signal is developed by summing said first signal with said baseline.

36. The apparatus of claim 31 comprising a first microphone positioned near the mouth of a user and configured to develop a first signal characterizing predominantly user speech, and a second microphone positioned away from the mouth of the user and configured to develop a second signal characterizing predominantly sounds other than user speech.

37. The apparatus of claim 31 wherein said signal characteristics comprises signal level.

38. The apparatus of claim 37 wherein said processing circuitry compares the signal levels of said plurality of signals.

39. The apparatus of claim 31 including speech processing circuitry configured to process said output signal only when user speech is present.

40. The apparatus of claim 39 wherein said speech processing circuitry is located in a central computer.

41. The apparatus of claim 39 wherein said speech processing circuitry is located in a body worn terminal.

42. The apparatus of claim 39 wherein said speech processing circuitry is located in a headset.

43. The apparatus of claim 36 wherein said first microphone is directional and said second microphone is omnidirectional.

44. A method for detecting user speech in a voice-driven environment, the method comprising:
detecting sound with first and second microphones to generate sound signals for the respective microphones;
locating the first microphone to detect a greater proportion of speech sounds of a user than the second microphone;
processing signal characteristics of the sound signals generated by the first microphone and the second microphone and based on the variations in those sound signal levels, determining if the user is speaking.

45. The method of claim 44 further comprising based on such a determination, further processing the first microphone sound signals.

46. The method of claim 44 further comprising using speech recognition for recognizing speech sounds detected by the first microphone.

47. The method of claim 44 further comprising positioning the microphones in a headset to be worn by a user.

48. The method of claim 44 wherein the signal characteristics include at least one of energy level characteristics, frequency characteristics, amplitude characteristics and phase characteristics.

49. The method of claim 44 further comprising:
when the user is not speaking, determining a variation in the signal characteristics for both the sound signals of the first and second microphones and using that variation as a baseline.

50. The method of claim 49 further comprising subsequently comparing the variation in the signal characteristics for both the first and second microphones to the baseline variation for determining if the user is speaking.

51. The method of claim 50 further comprising determining if the signal characteristics variation exceeds the baseline variation by a predetermined amount to determine if the user is speaking.

52. A method useful in a voice-driven system for detecting user speech, comprising:
developing a plurality of sound signals with signal characteristics from spaced locations on the body of a user, at least a first signal of said plurality of signals including a greater proportion of user speech than a second signal of said plurality of signals which is characterized predominantly by ambient sounds other than user speech; and
processing said plurality of signals for determining variations in their signal characteristics to develop an output signal that reveals the presence or absence of user speech.

53. The method of claim 52 wherein said processing generates a signal characteristic baseline from which said output signal is developed.

54. The method of claim 53 wherein said baseline is stored in a memory.

55. The method of claim 53 wherein said baseline represents a difference in signal level over a predetermined time base between said first and second signals.

56. The method of claim 52 wherein said output signal is developed by summing said first signal with said baseline.

57. The method of claim 52 comprising positioning a first microphone near the mouth of a user to develop said first signal characterizing predominantly user speech, and positioning a second microphone away from the mouth of the user to develop said second signal characterizing predominantly sounds other than user speech.

58. The method of claim 52 wherein said signal characteristics comprises signal level.

59. The method of claim 58 wherein said processing circuitry compares the signal levels of said plurality of signals.

60. The method of claim 52 including performing speech processing on said output signal only when user speech is present.
